(19) United States
(12) Patent Application Publication
(10) Pub. No.: US 2022/0063585 A1
(43) Pub. Date: Mar. 3, 2022

(54) IN-VEHICLE SYSTEM

(71) Applicant: TOYOTA JIDOSHA KABUSHIKI KAISHA, Toyota-shi (JP)

(72) Inventors: Atsushi TABATA, Okazaki-shi (JP); Koichi Okuda, Toyota-shi (JP); Masafumi Yamamoto, Nagakute-shi (JP); Yuuki Makino, Aichi-ken (JP); Shotaro Suzuki, Toyota-shi (JP)

(73) Assignee: TOYOTA JIDOSHA KABUSHIKI KAISHA, Toyota-shi (JP)

(21) Appl. No.: 17/404,351

(22) Filed: Aug. 17, 2021

(30) Foreign Application Priority Data
Aug. 25, 2020 (JP) 2020-142143

(51) Int. Cl. B60W 20/13; B60L 58/13; G06F 8/65; B60W 20/20

(52) U.S. Cl. CPC B60W 20/13; B60W 20/20; G06F 8/65; B60L 58/13

(57) ABSTRACT

An in-vehicle system that is to be provided in a vehicle. The in-vehicle system includes: (a) a control apparatus; (b) a first battery configured to supply an electric power to devices that are to be provided in the vehicle; and (c) a second battery provided apart from the first battery. The in-vehicle system is constructed such that rewriting of a software of the control apparatus is executable when an electric power switch of the vehicle is in an OFF state, and such that the rewriting of the software is executed with supply of the electric power from the second battery to the control apparatus when the electric power switch of the vehicle is in the OFF state.

This application claims priority from Japanese Patent Application No. 2020-142143 filed on Aug. 25, 2020, the disclosure of which is herein incorporated by reference in its entirety.

### FIELD OF THE INVENTION

The present invention relates to an in-vehicle system that is to be provided in a vehicle, wherein the in-vehicle system includes a control apparatus capable of rewriting a software.

### BACKGROUND OF THE INVENTION

There is known an in-vehicle system including an electronic control device (ECU) capable of rewriting a software. An example of such an in-vehicle system is disclosed in JP2019-64424A. This Japanese Patent Application Publication discloses that rewriting of the software of the electronic control device (ECU) is made with use of an electric power supplied from an auxiliary-device battery.

### SUMMARY OF THE INVENTION

By the way, it is possible to easily secure a time required for rewriting the software of the electronic control device (ECU) when an electric power switch (e.g., IG switch) of the vehicle is in an OFF state, so that it is desirable that the in-vehicle system is constructed to enable the software to be rewritable when the electric power switch is in the OFF state as well as when the electric power switch of the vehicle is in an ON state. However, in that case, where the rewriting of the software of the electronic control device (ECU) is executed with use of an electric power supplied from an auxiliary-device battery in the OFF state of the electric power switch, an amount of electric energy stored in the auxiliary-device battery is reduced so that there is a risk that the reduction of the stored electric energy amount could affect operations of devices (auxiliary devices) to which the electric power is to be supplied from the auxiliary-device battery.

The present invention was made in view of the background art described above. It is therefore an object of the present invention to provide an in-vehicle system including a control apparatus capable of rewriting a software, wherein the in-vehicle system is capable, when the software is to be rewritten in an OFF state of the electric power switch, of enabling the software to be rewritten while suppressing reduction of an amount of electric energy stored in an auxiliary-device battery.

The object indicated above is achieved according to the following aspects of the present invention.

According to a first aspect of the invention, there is provided an in-vehicle system that is to be provided in a vehicle, wherein the in-vehicle system includes: a control apparatus; a first battery configured to supply an electric power to devices that are to be provided in the vehicle; and a second battery provided apart from the first battery. The in-vehicle system is constructed such that rewriting of a software of the control apparatus is executable when an electric power switch of the vehicle is in an OFF state, and such that the rewriting of the software is executed with supply of the electric power from the second battery to the control apparatus when the electric power switch of the vehicle is in the OFF state. According to a first arrangement of the first aspect of the invention, the control apparatus is configured to control the vehicle by using the software, and is included in the devices to which the electric power is to be supplied from the first battery. According to a second arrangement of the first aspect of the invention, the in-vehicle system further includes: a rotating machine serving as a drive power source for driving the vehicle; and a main battery which is provided apart from the first and second batteries, and which is configured to supply the electric power to the rotating machine.

According to a second aspect of the invention, in the in-vehicle system according to the first aspect of the invention, the in-vehicle system is constructed such that the rewriting of the software of the control apparatus is executable when the electric power switch of the vehicle is in an ON state as well as when the electric power switch of the vehicle is in the OFF state, and such that the rewriting of the software is executed with the supply of the electric power from the second battery to the control apparatus when the electric power switch of the vehicle is in the ON state as well as when the electric power switch of the vehicle is in the OFF state.

According to a third aspect of the invention, in the in-vehicle system according to the first or second aspect of the invention, the second battery serves as an electric power source of an auxiliary device that is to be provided in the vehicle.

The in-vehicle system according to the first aspect of the invention is constructed such that the rewriting of the software of the control apparatus is executed with supply of the electric power from the second battery to the control apparatus when the electric power switch of the vehicle is in the OFF state, whereby reduction of a stored electric energy amount of the first battery is suppressed in the OFF state of the electric power switch. Consequently, it is possible to prevent negative influence on operations of the devices to which the electric power is to be supplied from the first battery, while rewriting the software of the control apparatus in the OFF state of the electric power switch.

The in-vehicle system according to the second aspect of the invention is constructed such that the rewriting of the software of the control apparatus is executable when the electric power switch of the vehicle is in the ON state as well as when the electric power switch of the vehicle is in the OFF state, and such that the rewriting of the software is executed with the supply of the electric power from the second battery to the control apparatus when the electric power switch of the vehicle is in the ON state as well as when the electric power switch of the vehicle is in the OFF state. Thus, the software of the control apparatus can be rewritten in the ON state of the electric power switch, and the electric power supplied from the second battery can be used even in the ON state of the electric power switch.

In the in-vehicle system according to the third aspect of the invention, the second battery can be used as the electric power source of the auxiliary device that is to be provided in the vehicle.

### BRIEF DESCRIPTION OF THE DRAWINGS

FIG. 1 is a view schematically showing a construction of a vehicle to which the present invention is applied;

FIG. 2 is a view schematically showing a construction of an in-vehicle system for controlling the vehicle of FIG. 1;

FIG. 3 is a table indicating a relationship between each gear position of a mechanically-operated step-variable transmission portion (shown in FIG. 1) and a combination of engagement devices of the step-variable transmission portion, which are to be placed in engaged states to establish the gear position in the step-variable transmission portion;

FIG. 4 is a collinear chart indicating a relationship among rotational speeds of rotary elements of an electrically-operated continuously-variable transmission portion (also shown in FIG. 1) and the mechanically-operated step-variable transmission portion;

FIG. 5 is a view showing, by way of example, an arrangement in which a vehicle control software or softwares are updated through a wireless communication;

FIG. 6 is a view showing, by way of examples, an AT-gear-position shifting map used for controlling gear shifting in the step-variable transmission portion (shown in FIG. 1), a running-mode switching map used for switching a running mode of the vehicle, and a relationship between the shifting map and the running-mode switching map;

FIG. 7 is a view showing a relationship between a data volume of received new software or softwares and a required electric energy amount required for rewriting that is to be made by the received new software or softwares; and

FIG. 8 is a flow chart showing a main part of a control routine executed by a vehicle control apparatus that constitutes the in-vehicle system, namely, a control routine that is executed for rewriting the software or softwares in an OFF state of an electric power switch and securing the required electric energy amount required for rewriting the software or softwares.

### DETAILED DESCRIPTION OF PREFERRED EMBODIMENT

There will be described an embodiment of the invention in detail with reference to the accompanying drawings. It is noted that figures of the drawings are simplified or deformed as needed and portions are not necessarily precisely depicted in terms of dimension ratio, shape, etc.

### Embodiment

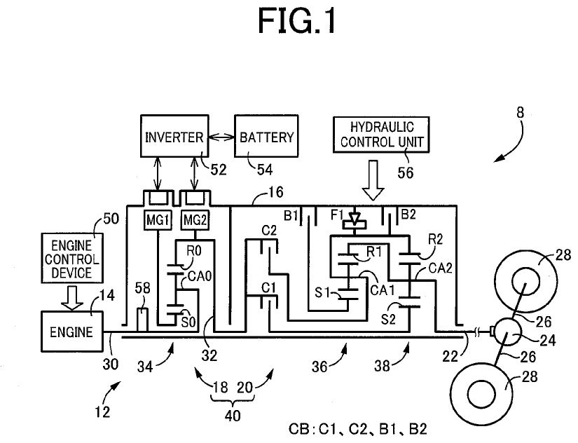

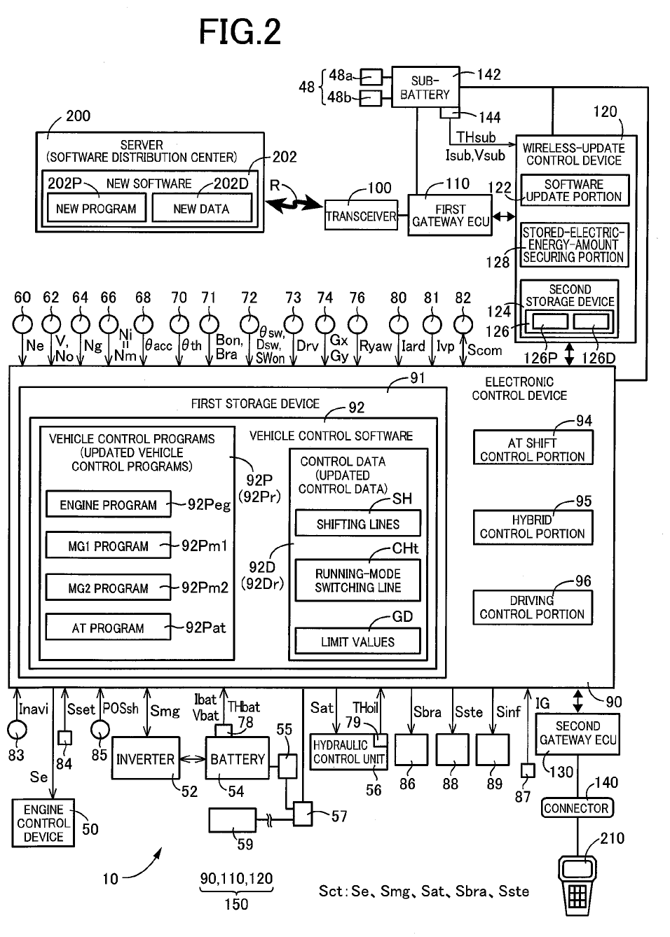

FIG. 1 is a view schematically showing a construction of a vehicle 8 to which the present invention is applied. FIG. 2 is a view schematically showing a construction of an in-vehicle system 10 for executing various control operations in the vehicle 8 of FIG. 1. As shown in FIG. 1, the vehicle 8 includes a power transmission apparatus 12, an engine 14 and first and second rotating machines MG1, MG2.

The in-vehicle system 10 shown in FIG. 2 is provided in the vehicle 8, so as to execute the various control operations in the vehicle 8. As shown in FIG. 2, the in-vehicle system 10 includes an electronic control device 90, a first gateway ECU 110, a wireless-update control device 120, a second gateway ECU 130, a high-voltage battery 54 configured to supply an electric power to the first and second rotating machines MG1, MG2, an auxiliary-device battery 57 configured to supply the electric power to devices provided in the vehicle 8, and a sub-battery 142.

The engine 14 is a known internal combustion engine such as gasoline engine and diesel engine, which serves as a drive power source capable of generating a drive power. The vehicle 8 is provided with an engine control device 50 that includes a throttle actuator, a fuel injection device and an ignition device. With the engine control device 50 being controlled by the electronic control device 90 that is described below, an engine torque Te, which is an output torque of the engine 14, is controlled.

Each of the first and second rotating machines MG1, MG2 is a rotating electric machine having a function serving as an electric motor and a function serving as a generator. That is, each of the first and second rotating machines MG1, MG2 is a so-called “motor generator”. The first and second rotating machines MG1, MG2 are connected to a high-voltage battery 54 provided in the vehicle 8, through an inverter 52 provided in the vehicle 8. The inverter 52 is controlled by the electronic control device 90 whereby an MG1 torque Tg and an MG2 torque Tm as output torques of the respective first and second rotating machines MG1, MG2 are controlled. The output torque of each of the first and second rotating machines MG1, MG2 serves as a power running torque when acting as a positive torque for acceleration, with the each of the first and second rotating machines MG1, MG2 being rotated in a forward direction that is the same as a direction of rotation of the engine 14 during operation of the engine 14. The output torque of each of the first and second rotating machines MG1, MG2 serves as a regenerative torque when acting as a negative torque for deceleration, with the each of the first and second rotating machines MG1, MG2 being rotated in the forward direction. The high-voltage battery 54 is an electric storage device to and from which the electric power is supplied from and to the first rotating machine MG1 and the second rotating machine MG2. The first and second rotating machines MG1, MG2 are disposed inside a casing 16 that is a non-rotary member that is attached to a body of the vehicle 8. It is noted that the high-voltage battery 54 corresponds to “main battery” recited in the appended claims.

As shown in FIG. 2, the high-voltage battery 54 is connected to a DCDC convertor 55 that is configured to reduce a battery voltage of the high-voltage battery 54 and charge the auxiliary-device battery 57 with the reduced battery voltage. The electric power, with which the auxiliary-device battery 57 is charged, is supplied to devices 59 provided in the vehicle 8, wherein the devices 59 include the electronic control device 90, first gateway ECU 110, wireless-update control device 120, second gateway ECU 130, vehicle lamps (not shown), an audio device (not shown), a compressor 48a of an air conditioner and an electrically-operated oil pump 48b. The devices 59 include not only the electronic control device 90, first gateway ECU 110, wireless-update control device 120, second gateway ECU 130, vehicle lamps, audio device, compressor 48a and electrically-operated oil pump 48b, but also all of electrically-operated devices such as various sensors, which are to be operated by the electric power supplied from the auxiliary-device battery 57. It is noted that the auxiliary-device battery 57 corresponds to “first battery” recited in appended claims.

The power transmission apparatus 12 includes, in addition to the casing 16, an electrically-operated continuously-variable transmission portion 18 and a mechanically-operated step-variable transmission portion 20. The continuously-variable transmission portion 18 and the step-variable transmission portion 20 are provided within the casing 16, and are arranged in a series on a common axis. The continuously-variable transmission portion 18 is connected to the engine 14 directly or indirectly through, for example, a damper (not shown). The step-variable transmission portion 20 is connected to an output rotary member of the continuously-variable transmission portion 18. The power transmission apparatus 12 further includes a differential gear device 24 connected to an output shaft 22 that is an output rotary member of the step-variable transmission portion 20, and a pair of axles 26 connected to the differential gear device 24. The axles 26 are connected to drive wheels 28 of the vehicle 8. It is noted that the power transmission apparatus 12 including the continuously-variable transmission portion 18 and the step-variable transmission portion 20 is constructed substantially symmetrically about its axis corresponding to the above-described common axis, so that a lower half of the power transmission apparatus 12 is not shown in FIG. 1. The above-described common axis corresponds to axes of a crank shaft of the engine 14 and a connection shaft 30 that is an input rotary member of the continuously-variable transmission portion 18 connected to the crank shaft.

The continuously-variable transmission portion 18 is provided with: the above-described first rotating machine MG1; and a differential mechanism 34 serving as a drive-power distributing device to mechanically distribute the drive power of the engine 14 to the first rotating machine MG1 and to an intermediate transmission member 32 that is an output rotary member of the continuously-variable transmission portion 18. To the intermediate transmission member 32, the above-described second rotating machine MG2 is connected in a drive-power transmittable manner. The continuously-variable transmission portion 18 is an electrically-operated continuously-variable transmission wherein a differential state of the differential mechanism 34 is controllable by controlling an operation state of the first rotating machine MG1. The continuously-variable transmission portion 18 is operated as the electrically-operated continuously-variable transmission whose gear ratio (that is referred also to as “speed ratio”) γ0 (=engine rotational speed Ne/MG2 rotational speed Nm) is changeable. The engine rotational speed Ne is a rotational speed of the engine 14, and is equal to an input rotational speed of the continuously-variable transmission portion 18, i.e., a rotational speed of the connection shaft 30. The MG2 rotational speed Nm is a rotational speed of the second rotating machine MG2, and is equal to an output rotational speed of the continuously-variable transmission portion 18, i.e., a rotational speed of the intermediate transmission member 32. The first rotating machine MG1 is a rotating machine capable of controlling the engine rotational speed Ne, and corresponds to a differential rotating machine. It is noted that controlling the operation state of the first rotating machine MG1 is controlling an operation of the first rotating machine MG1.

The differential mechanism 34 is a planetary gear device of a single-pinion type having a sun gear S0, a carrier CA0 and a ring gear R0. The carrier CA0 is connected to the engine 14 through the connection shaft 30 in a drive-power transmittable manner, and the sun gear S0 is connected to the first rotating machine MG1 in a drive-power transmittable manner, while the ring gear R0 is connected to the second rotating machine MG2 in a drive-power transmittable manner. In the differential mechanism 34, the carrier CA0 serves as an input element, and the sun gear S0 serves as a reaction element, while the ring gear R0 serves as an output element.

The step-variable transmission portion 20 is a mechanically-operated transmission mechanism as a step-variable transmission which constitutes a part of a drive-power transmission path between the intermediate transmission member 32 and the drive wheels 28, namely, constitutes a part of a drive-power transmission path between the continuously-variable transmission portion 18 and the drive wheels 28. The intermediate transmission member 32 also serves as an input rotary member of the step-variable transmission portion 20, and is connected to the second rotating machine MG2 so as to be rotatable integrally with the second rotating machine MG2. The second rotating machine MG2 is a rotating machine serving as a drive power source capable of generating a drive power, and corresponds to a rotating machine for driving the vehicle 8. Further, the engine 14 is connected to an input rotary member of the continuously-variable transmission portion 18, so that the step-variable transmission portion 20 is considered to also as a vehicle transmission constituting a part of a drive-power transmission path between the drive power source (second rotating machine MG2 or engine 14) and the drive wheels 28. The step-variable transmission portion 20 is a known automatic transmission of a planetary gear type which is provided with a plurality of planetary gear devices in the form of a first planetary gear device 36 and a second planetary gear device 38, and a plurality of engagement devices including a one-way clutch F1, a clutch C1, a clutch C2, a brake B1 and a brake B2. Hereinafter, the clutch C1, clutch C2, brake B1 and brake B2 will be referred to as engagement devices CB unless they are to be distinguished from each other.

Each of the engagement devices CB is a hydraulically-operated frictional engagement device in the form of a multiple-disc type or a single-disc type clutch or brake that is to be pressed by a hydraulic actuator, or a band brake that is to be tightened by a hydraulic actuator. A torque capacity of each of the engagement devices CB is to be changed by an engaging pressure in the form of a corresponding one of hydraulic pressures as regulated pressures supplied from solenoid valves (not shown), for example, of a hydraulic control unit (hydraulic control circuit) 56 provided in the vehicle 8, whereby an operation state of each of the engagement devices CB is to be switched among engaged, slipped and released states, for example.

In the step-variable transmission portion 20, selected ones of rotary elements of the first and second planetary gear devices 36, 38 are connected to each other or to the intermediate transmission member 32, casing 16 or output shaft 22, either directly or indirectly through the engagement devices CB or the one-way clutch F1. The rotary elements of the first planetary gear device 36 are a sun gear S1, a carrier CA1 and a ring gear R1. The rotary elements of the second planetary gear device 38 are a sun gear S2, a carrier CA2 and a ring gear R2.

The step-variable transmission portion 20 is shifted to a selected one of a plurality of gear positions (speed positions) by engaging actions of selected ones of the engagement devices CB. The plurality of gear positions have respective different gear ratios (speed ratios) γat (=AT input rotational speed Ni/output rotational speed No). Namely, the step-variable transmission portion 20 is shifted up and down from one gear position to another by placing selected ones of the engagement devices in the engaged state. In the following description of the present embodiment, the gear position established in the step-variable transmission portion 20 will be referred to as an AT gear position. The AT input rotational speed Ni is an input rotational speed of the step-variable transmission portion 20 that is a rotational speed of the input rotary member of the step-variable transmission portion 20, which is equal to the rotational speed of the intermediate transmission member 32, and which is equal to the MG2 rotational speed Nm that is the rotational speed of the second rotating machine MG2. Thus, the AT input rotational speed Ni can be represented by the MG2 rotational speed Nm. The output rotational speed No is a rotational speed of the output shaft 22 that is an output rotational speed of the step-variable transmission portion 20, which is considered to be an output speed of a transmission device (composite transmission) 40 which consists of the continuously-variable transmission portion 18 and the step-variable transmission portion 20. It is noted that the engine rotational speed Ne corresponds to also an input rotational speed of the transmission device 40.

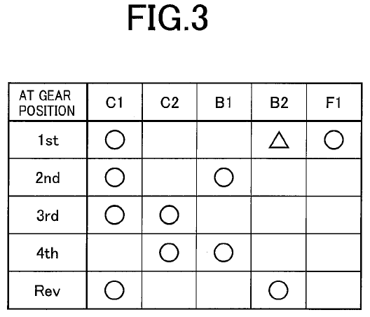

As shown in a table of FIG. 3, the step-variable transmission portion 20 is configured to establish a selected one of a plurality of AT gear positions in the form of four forward AT gear positions and a reverse AT gear position. The four forward AT gear positions consist of a first speed AT gear position, a second speed AT gear position, a third speed AT gear position and a fourth speed AT gear position, which are represented by “1st”, “2nd”, “3rd” and “4th” in the table of FIG. 3. The first speed AT gear position is the lowest-speed gear position having a highest gear ratio γat, while the fourth speed AT gear position is the highest-speed gear position having a lowest gear ratio γat. The gear ratio γat decreases in a direction from the first speed AT gear position (lowest-speed gear position) toward the fourth speed AT gear position (highest-speed gear position). The reverse AT gear position is represented by “Rev” in the table of FIG. 3, and is established by, for example, engagements of the clutch C1 and the brake B2. That is, when the vehicle 8 is to run in reverse direction, the first speed AT gear position is established, for example. The table of FIG. 3 indicates a relationship between each of the AT gear positions of the step-variable transmission portion 20 and operation states of the respective engagement devices CB of the step-variable transmission portion 20, namely, a relationship between each of the AT gear positions and a combination of ones of the engagement devices CB, which are to be placed in theirs engaged states to establish the each of the AT gear positions. In the table of FIG. 3, “O” indicates the engaged state of the engagement devices CB, “A” indicates the engaged state of the brake B2 during application of an engine brake to the vehicle 8 or during a coasting shift-down action of the step-variable transmission portion 20, and the blank indicates the released state of the engagement devices CB.

The step-variable transmission portion 20 is configured to switch from one of the AT gear positions to another one of the AT gear positions, namely, to establish one of the AT gear positions which is selected, by the electronic control device 90, according to, for example, an accelerating operation made by a vehicle driver (operator) and a vehicle running speed V. The step-variable transmission portion 20 is shifted up or down from one of the AT gear positions to another, for example, by so-called “clutch-to-clutch” shifting operation that is made by releasing and engaging actions of selected two of the engagement devices CB, namely, by a releasing action of one of the engagement devices CB and an engaging action of another one of the engagement devices CB.

The vehicle 8 further includes the electrically-operated oil pump 48b and an MOP 58 that is a mechanically-operated oil pump. The MOP 58 is connected to the connection shaft 30, and is to be rotated together with rotation of the engine 14, so as to output a working fluid that is to be used in the power transmission apparatus 12. The electrically-operated oil pump 48b is to driven to output the working fluid, for example, when the engine 14 is stopped, namely, when the MOP 58 is not driven. The working fluid outputted by the MOP 58 and the electrically-operated oil pump 48b is supplied to the hydraulic control unit 56, such that the working fluid is regulated to the engaging pressure by the hydraulic control unit 56, and the operation state of each of the engagement devices CB is switched by the engaging pressure.

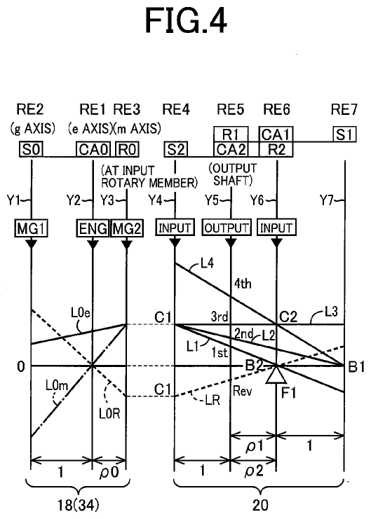

FIG. 4 is a collinear chart representative of a relative relationship of rotational speeds of the rotary elements in the continuously-variable transmission portion 18 and the step-variable transmission portion 20. In FIG. 4, three vertical lines Y1, Y2, Y3 corresponding to the three rotary elements of the differential mechanism 34 constituting the continuously-variable transmission portion 18 are a g-axis representative of the rotational speed of the sun gear S0 corresponding to a second rotary element RE2, an e-axis representative of the rotational speed of the carrier CA0 corresponding to a first rotary element RE1, and an m-axis representative of the rotational speed of the ring gear R0 corresponding to a third rotary element RE3 (i.e., the input rotational speed of the step-variable transmission portion 20) in order from the left side. Four vertical lines Y4, Y5, Y6, Y7 of the step-variable transmission portion 20 are axes respectively representative of the rotational speed of the sun gear S2 corresponding to a fourth rotary element RE4, the rotational speed of the ring gear R1 and the carrier CA2 connected to each other and corresponding to a fifth rotary element RE5 (i.e., the rotational speed of the output shaft 22), the rotational speed of the carrier CA1 and the ring gear R2 connected to each other and corresponding to a sixth rotary element RE6, and the rotational speed of the sun gear S1 corresponding to a seventh rotary element RE7 in order from the left. An interval between the vertical lines Y1, Y2, Y3 is determined in accordance with a gear ratio ρ0 of the differential mechanism 34. An interval between the vertical lines Y4, Y5, Y6, Y7 is determined in accordance with gear ratios ρ1, ρ2 of the first and second planetary gear devices 36, 38. When an interval between the sun gear and the carrier is set to an interval corresponding to “1” in the relationship between the vertical axes of the collinear chart, an interval corresponding to the gear ratio ρ (=the number of teeth of the sun gear/the number of teeth of the ring gear) of the planetary gear device is set between the carrier and the ring gear.

In representation using the collinear chart of FIG. 4, in the differential mechanism 34 of the continuously-variable transmission portion 18, the engine 14 (see “ENG” in FIG. 4) is connected to the first rotary element RE1, the first rotating machine MG1 (see “MG1” in FIG. 4) is connected to the second rotary element RE2, the second rotating machine MG2 (see “MG2” in FIG. 4) is connected to the third rotary element RE3 that is to be rotated integrally with the intermediate transmission member 32, and therefore, the rotation of the engine 14 is transmitted via the intermediate transmission member 32 to the step-variable transmission portion 20. In the continuously-variable transmission portion 18, the relationship between the rotational speed of the sun gear S0 and the rotational speed of the ring gear R0 is indicated by straight lines L0e, L0m and L0R crossing the vertical line Y2.

In the step-variable transmission portion 20, the fourth rotary element RE4 is selectively connected through the clutch C1 to the intermediate transmission member 32; the fifth rotary element RE5 is connected to the output shaft 22; the sixth rotary element RE6 is selectively connected through the clutch C2 to the intermediate transmission member 32 and selectively connected through the brake B2 to the casing 16; and the seventh rotary element RE7 is selectively connected through the brake B1 to the casing 16. In the step-variable transmission portion 20, the rotational speeds of “1st”, “2nd”, “3rd”, “4th”, and “Rev” of the output shaft 22 are indicated by respective straight lines L1, L2, L3, L4, LR crossing the vertical line Y5 in accordance with engagement/release control of the engagement devices CB.

The straight line L0e and the straight lines L1, L2, L3, L4 indicated by solid lines in FIG. 4 indicate relative speeds of the rotary elements during forward running in an HV running mode enabling an HV running (hybrid running) in which at least the engine 14 is used as the drive power source for driving the vehicle 8. The HV running is an engine running in which at least the drive power of the engine 14 is used for driving the vehicle 8. In this HV running mode, when a reaction torque, i.e., a negative torque from the first rotating machine MG1, is inputted in positive rotation to the sun gear S0 with respect to the engine torque Te inputted to the carrier CA0 in the differential mechanism 34, an engine direct transmission torque Td [=Te/(1+ρ0)=−(1/ρ0)×Tg] appears in the ring gear R0 as a positive torque in positive rotation. A combined torque of the engine direct transmission torque Td and the MG2 torque Tm is transmitted as a drive torque of the vehicle 8 in the forward direction depending on a required drive force to the drive wheels 28 through the step-variable transmission portion 20 having any AT gear position formed out of the first to fourth speed AT gear positions. In this case, the first rotating machine MG1 functions as an electric generator generating the negative torque in positive rotation. A generated electric power Wg of the first rotating machine MG1 is stored in the high-voltage battery 54 or consumed by the second rotating machine MG2. The second rotating machine MG2 outputs the MG2 torque Tm by using all or a part of the generated electric power Wg or using the electric power from the high-voltage battery 54 in addition to the generated electric power Wg. Thus, the first rotating machine MG1 is a rotating machine configured to output the reaction torque acting against the engine torque Te, for thereby causing the drive power of the engine 14 to be transmitted.

The straight line L0m indicated by one-dot chain line and the straight lines L1, L2, L3, L4 indicated by solid lines in FIG. 4 indicate the relative speeds of the rotary elements during forward running in an EV running mode enabling an EV running (motor running) in which the second rotating machine MG2 is used as the drive power source for driving the vehicle 8 with operation of the engine 14 being stopped. The EV running is a motor running in which only the drive power of the second rotating machine MG2 is used for driving the vehicle 8. During the forward running in the EV running mode, the carrier CA0 is not rotated while the MG2 torque Tm is inputted to the ring gear R0 in positive rotation so as to act as the positive torque. In this instance, the first rotating machine MG1 connected to the sun gear S0 is placed in a non-load state and freely rotatable in negative direction. Namely, during the forward running in the EV running mode, the engine 14 is not driven, so that the engine rotational speed Ne is kept zero, and the MG2 torque Tm is transmitted as a forward drive torque to the drive wheels 28 through the step-variable transmission portion 20 placed in one of the first through fourth speed AT gear positions. During this forward running in the EV running mode, the MG2 torque Tm is a power running torque that is a positive torque in positive rotation.

The straight lines L0R and LR indicated by broken lines in FIG. 4 indicate the relative speeds of the rotary elements during reverse running in the EV running mode. During the reverse running in this EV running mode, the MG2 torque Tm is inputted to the ring gear R0 in negative rotation so as to act as the negative torque, and the MG2 torque Tm is transmitted as the drive torque acting on the vehicle 8 in a reverse direction to the drive wheels 28 through the step-variable transmission portion 20 in which the first speed AT gear position is established. The vehicle 8 can perform the reverse running when the electronic control device 90 causes the second rotating machine MG2 to output a reverse MG2 torque Tm having a positive/negative sign opposite to a forward MG2 torque Tm outputted during forward running while a forward low-side AT gear position such as the first speed AT gear position is established as one the plurality of AT gear positions. During the reverse running in the EV running mode, the MG2 torque Tm is a power running torque that is a negative torque in negative rotation. It is noted that, even in the HV running mode, the reverse running can be performed as in the EV running mode, since the second rotating machine MG2 can be rotated in negative direction as indicated by the straight line L0R.

The vehicle 8 is a hybrid vehicle having the engine 14 and the second rotating machine MG2 as the drive power sources for driving the vehicle 8. In the power transmission apparatus 12, the drive power outputted from the engine 14 or the second rotating machine MG2 is transmitted to the step-variable transmission portion 20, and is then transmitted from the step-variable transmission portion 20 to the drive wheels 28, for example, through the differential gear device 24. Thus, the power transmission apparatus 12 is configured to transmit the drive power of the drive power sources in the form of the engine 14 and the second rotating machine MG2, to the drive wheels 28. It is noted that the power corresponds to a torque or a force unless otherwise distinguished from them.

FIG. 2 is a view showing an input/output system of the electronic control device 90, first gateway ECU 110, wireless-update control device 120 and second gateway ECU 130 that cooperate with one another to constitute the in-vehicle system 10, and is also a functional block diagram explaining major portions of control functions of the electronic control device 90 and wireless-update control device 120.

The vehicle 8 is provided with the electronic control device 90 as a controller including a control device that is configured to control, for example, the engine 14, continuously-variable transmission portion 18 and step-variable transmission portion 20. The electronic control device 90 includes a so-called microcomputer incorporating a CPU, a ROM, a RAM and an input-output interface, for example. The CPU performs control operations of the vehicle 8, by processing various input signals, in accordance with control programs stored in the ROM, while utilizing a temporary data storage function of the RAM. The electronic control device 90 may be constituted by two or more control units exclusively assigned to perform respective control operations such as a control operation for controlling the drive power sources and a control operation for controlling the step-variable transmission.

The electronic control device 90 receives various input signals based on values detected by respective sensors provided in the vehicle 8. Specifically, the electronic control device 90 receives: an output signal of an engine speed sensor 60 indicative of the engine rotational speed Ne; an output signal of an output speed sensor 62 indicative of the output rotational speed No which is the rotational speed of the output shaft 22 and corresponds to the running speed V of the vehicle 8; an output signal of a MG1 speed sensor 64 indicative of an MG1 rotational speed Ng which is a rotational speed of the first rotating machine MG1; an output signal of a MG2 speed sensor 66 indicative of the MG2 rotational speed Nm which is the rotational speed of the second rotating machine MG2 and which corresponds to the AT input rotational speed Ni; an output signal of an accelerator-opening degree sensor 68 indicative of an accelerator opening degree θacc representing an amount of accelerating operation made by the vehicle driver; an output signal of a throttle-valve-opening degree sensor 70 indicative of a throttle opening degree θth; an output signal of a brake pedal sensor 71 indicative of a brake-ON signal Bon representing a state of depression of a brake pedal by the vehicle driver to operate wheel brakes and also a braking operation amount Bra representing an amount of depression of the brake pedal by the vehicle driver; an output signal of a steering sensor 72 indicative of a steering angle θsw and a steering direction Dsw of a steering wheel provided in the vehicle 8 and also a steering ON signal SWon representing a state in which the steering wheel is being held by the vehicle driver; an output signal of a driver condition sensor 73 indicative of a driver condition signal Dry representing a condition of the vehicle driver; an output signal of a G sensor 74 indicative of a longitudinal acceleration Gx and a lateral acceleration Gy of the vehicle 8; an output signal of a yaw rate sensor 76 indicative of a yaw rate Ryaw that is an angular speed around a vertical axis of the vehicle 8; an output signal of a first battery sensor 78 indicative of a battery temperature THba, a charging/discharging electric current Ibat and a voltage Vbat of the high-voltage battery 54; an output signal of a fluid temperature sensor 79 indicative of a working fluid temperature THoil that is a temperature of the working fluid; an output signal of a vehicle-area information sensor 80 indicative of vehicle area information lard; an output signal of a vehicle location sensor 81 indicative of location information Ivp; an output signal of an external-network communication antenna 82 indicative of an communication signal Scom; an output signal of a navigation system 83 indicative of navigation information Inavi; output signals of drive-assist setting switches 84 indicative of drive-assist setting signals Sset representing a setting made by the vehicle driver for execution of a drive-assist control such as automatic drive control and a cruise control; an output signal of a shift position sensor 85 indicative of an operation position POSsh of a shift lever provided in the vehicle 8; and an output signal of an electric power switch 87 indicative of a signal IG that represents whether the electric power switch 87 is in an ON state or an OFF state.

The amount of the accelerating operation made by the vehicle driver is, for example, an amount of operation of an acceleration operating member such as an accelerator pedal, and corresponds to a required output amount that is an amount of output of the vehicle 8 required by the vehicle driver. As the required output amount required by the vehicle driver, the throttle opening degree θth can be used in addition to or in place of the accelerator opening degree θacc, for example.

The driver condition sensor 73 includes a camera configured to photograph, for example, a facial expression and pupils of eyes of the vehicle driver and/or a biometric information sensor configured to detect biometric information of the vehicle driver, so as to detect or obtain directions of his or her eyes and face, movements of his or her eye balls and face and condition of his or her heartbeat, for example.

The vehicle-area information sensor 80 includes a lidar (Light Detection and Ranging), a radar (Radio Detection and Ranging) and/or an onboard camera, for example, so as to directly obtain information relating to a road on which the vehicle 8 is running and information relating to an object or objects present around the vehicle 8. The lidar is constituted by, for example, a plurality of lidar units configured to detect objects present in the respective front, lateral and rear sides of the vehicle 8, or a single lidar unit configured to detect objects present all around the vehicle 8. The lidar is configured to output, as the vehicle area information lard, object information that is information relating to the detected object or objects. The radar is constituted by, for example, a plurality of radar units configured to detect objects present in the respective front, front vicinity and rear vicinity of the vehicle 8, and to output, as the vehicle area information lard, object information that is information relating to the detected object or objects. The objected information outputted as the vehicle area information lard by the lidar and the radar includes a distance and a direction of each of the detected objects from the vehicle 8. The onboard camera is, for example, a monocular camera or a stereo camera configured to capture images of front and rear sides of the vehicle 8, and to output, as the vehicle area information lard, captured image information that is information relating to the captured images. The captured image information outputted as the vehicle area information lard by the onboard camera includes information relating to lanes of a running road, signs and parking spaces present on the running road, and at least one other vehicle (that is other than the vehicle 8), pedestrians and obstacles present on the running road.

The vehicle location sensor 81 includes a GPS antenna. The location information Ivp outputted by the vehicle location sensor 81 includes own-vehicle location information indicating a location of the vehicle 8 on the earth's surface or a map based on, for example, GPS signals (Orbit signals) transmitted by GPS (Global Positioning System) satellites.

The navigation system 83 is a known navigation system including a display and a speaker, and is configured to specify a location of the vehicle 8 on pre-stored map data, based on the location information Ivp, and to indicate the location of the vehicle 8 on the map displayed on the display. The navigation system 83 receives a destination point inputted thereto, calculates a running route from a departure point to the destination point, and informs, as instructions, the vehicle driver of the running route, for example, through the display and the speaker. The navigation information Inavi includes map information such as road information and facility information that are based on the map data pre-stored in the navigation system 83. The road information includes information relating to types of roads (such as urban roads, suburban roads, mountain roads and highway road), branching and merging of roads, road gradients, and running speed limits. The facility information includes information of types, locations, names of sites such as supermarkets, shops, restaurants, parking lots, parks, sites for repairing the vehicle 8, a home of vehicle's owner and service areas located on the highway road. The service areas are sites which are located on, for example, the highway road, and in which there are facilities for parking, eating, and refueling.

The drive-assist setting switches 84 include an automatic-drive selecting switch for executing the automatic drive control, a cruise switch for executing the cruise control, a switch for setting the vehicle running speed in execution of the cruise control, a switch for setting a distance from another vehicle preceding the vehicle 8 in execution of the cruise control, and a switch for executing a lane keeping control for keeping the vehicle 8 to run within a selected road lane.

The communication signal Scom includes road traffic information that is transmitted and received to and from a center that is an external device such as a road traffic information communication system, and/or inter-vehicle communication information that is directly transmitted and received to and from the at least one other vehicle present in the vicinity of the vehicle 8 without via the center. The road traffic information includes information relating to traffic jams, accidents, road constructions, required travel times, and parking lots on roads. The inter-vehicle communication information includes vehicle information, running information, traffic environment information. The vehicle information includes information indicative of a vehicle type of the at least one other vehicle such as passenger vehicle, truck, and two-wheel vehicle. The running information includes information relating to the at least one other vehicle such as information indicative of the vehicle running speed V, location information, brake-pedal operation information, turn-signal-lamp blinking information, and hazard-lamp blinking information. The traffic environment information includes information relating to traffic jams and road constructions.

The electronic control device 90 generates various output signals to the various devices provided in the vehicle 8, such as: an engine control command signal Se that is to be supplied to the engine control device 50 for controlling the engine 14, rotating-machine control command signals Smg that are to be supplied to the inverter 52 for controlling the first and second rotating machines MG1, MG2; hydraulic control command signal Sat that is to be supplied to the hydraulic control unit 56 for controlling the operation states of the engagement devices CB; the communication signal Scom that is to be supplied to the external-network communication antenna 82; a brake-control command signal Sbra that is supplied to a wheel brake device 86, for controlling a braking torque generated by the wheel brake device 86; a steering-control command signal Sste that is to be supplied to a steering device 88, for controlling steering of wheels (especially, front wheels) of the vehicle 8; and an information-notification-control command signal Sinf that is to be supplied to an information notification device 89, for warning and notifying information to the vehicle driver.

The wheel brake device 86 is a brake device including wheel brakes each of which is configured to apply a braking torque to a corresponding one of the wheels that include the drive wheels 28 and driven wheels (not shown). The wheel brake device 86 supplies a brake hydraulic pressure to a wheel cylinder provided in each of the wheel brakes in response to a depressing operation of the brake pedal by the vehicle driver, for example. In the wheel brake device 86, normally, a brake master cylinder is configured to generate a master-cylinder hydraulic pressure whose magnitude corresponds to the braking operation amount Bra, and the generated master-cylinder hydraulic pressure is supplied as the brake hydraulic pressure to the wheel cylinder. On the other hand, in the wheel brake device 86, for example, during execution of an ABS control, an anti-skid control, a vehicle-running-speed control or an automatic drive control, the brake hydraulic pressure required for execution of such a control is supplied to the wheel cylinder for enabling the wheel cylinder to generate a required braking torque.

The steering device 88 is configured to apply an assist torque to a steering system of the vehicle 8 in accordance with the vehicle running speed V, steering angle θsw, steering direction Dsw and yaw rate Ryaw, for example. For example, during execution of the automatic drive control, the steering device 88 applies a torque for controlling the steering of the front wheels, to the steering system of the vehicle 8.

The information notification device 89 is configured to give a warning or notification to the vehicle driver in event of a failure that affects the running of the vehicle 8 or deterioration in functions of the components, for example. The information notification device 89 is constituted by, for example, a display device such as a monitor, a display and an alarm lamp, and/or a sound output device such as a speaker and a buzzer. The display device is configured to visually give a warning or notification to the vehicle driver. The sound output device is configured to aurally give a warning or notification to the vehicle driver.

The vehicle 8 includes a transceiver 100, the first gateway ECU 110, the wireless-update control device 120, the second gateway ECU 130 and a connector 140.

The transceiver 100 is a device configured to communicate with a server 200 as an external device which is present apart from the vehicle 8 and is provided outside the vehicle 8.

Each of the first gateway ECU 110, wireless-update control device 120 and second gateway ECU 130 has substantially the same hardware construction as the electronic control device 90, and is a control device configured to rewrite a plurality of kinds of vehicle control softwares 92 that are stored in, for example, a first storage device 91 (such as a rewritable ROM) provided in the electronic control device 90. The vehicle control softwares 92 are softwares that are to be used for a plurality of kinds of control operations in the vehicle 8. That is, the electronic control device 90 is constructed to be capable of rewriting the vehicle control softwares 92 stored in the first storage device 91. The vehicle control softwares 92 include a plurality of kinds of vehicle control programs 92P each defining a control procedure according to which the vehicle 8 is to be controlled, and also a plurality of kinds of control data 92D each of which is to be used when the vehicle 8 is controlled in accordance with a corresponding one of the vehicle control programs 92P. It is noted that each of the vehicle control softwares 92 corresponds to “software” recited in the appended claims.

The connector 140 is provided to enable an external rewriting device 210 to be connected to the vehicle 8, wherein the external rewriting device 210 is an external device which is present apart from the vehicle 8 and is provided outside the vehicle 8. A shape of the connector 140 and an electrical signal that is to be transmitted through the connector 140 are defined or determined by a known standard. The connector 140 can be used as a connector through which a failure diagnostic device is connected to the vehicle 8. As the standard of the connector 140, there are OBD (On-Board Diagnostics), WWH-OBD (World Wide Harmonized-OBD), KWP (Keyword Protocol) and UDS (Unified Diagnostic Services), for example. The connector 140 is referred to as OBD connector, DLC connector or failure diagnostic connector, for example.

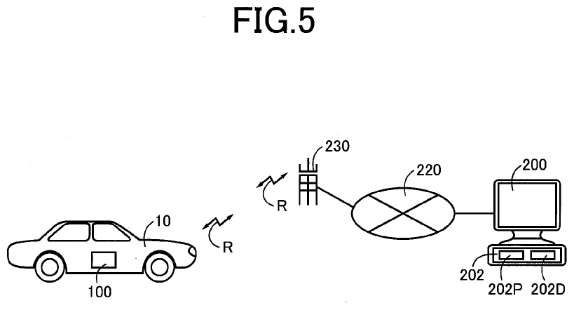

As shown in FIG. 5, the server 200 is a system connected to a network 220 that is provided outside the vehicle 8. The server 200 is configured to store therein new softwares 202 uploaded thereto, and to transmit the new softwares 202 to the vehicle 8 as needed. The server 200 serves as a software distribution center for distributing the plurality of kinds of new softwares 202. The plurality of kinds of new softwares 202 are softwares to each of which a corresponding one of the vehicle control softwares 92 is to be updated. The new softwares 202 include a plurality of kinds of new programs 202P to each of which a corresponding one of the vehicle control programs 92P is to be updated, and also a plurality of kinds of new data 202D to each of which a corresponding one of the control data 92D is to be updated. Each of the new programs 202P is to become an updated vehicle control program 92Pr after the corresponding current vehicle control program 92P is updated to the new program 202P, namely, after the corresponding current vehicle control program 92P is rewritten to the new program 202P. Each of the new data 202D is to become an updated control data 92Dr after the corresponding current control data 92D is updated to the new data 202D, namely, after the corresponding current control data 92D is rewritten to the new data 202D.

The external rewriting device 210 is to be connected directly to an in-vehicle network of the vehicle 8, so that the external rewriting device 210 as well as the electronic control device 90, for example, can receive CAN (Controller Area Network) frame through the in-vehicle network and transmit the CAN frame to the in-vehicle network.

As shown in FIG. 5, the transceiver 100 is connected through a wireless communication R to the network 220 that is connected to a wireless device 230 through the wireless communication R. The wireless device 230, which is located outside the vehicle 8, is a transceiver device configured to transmit and receive various signals through the wireless communication R.

The first gateway ECU 110 is connected to the transceiver 100, and is configured to receive, as needed, the plurality of kinds of new softwares 202 transmitted from the server 200 through the wireless communication R, and to transmit the received new softwares 202 to the wireless-update control device 120. It is noted that the wireless communication R may be made between the vehicle 8 and the server 200 also through the external-network communication antenna 82.

The wireless-update control device 120 is a control device configured to supervise writing and rewriting of the plurality of kinds of vehicle control softwares 92 through the wireless communication R in the vehicle 8. The wireless-update control device 120 is configured to rewrite the plurality of kinds of vehicle control softwares 92 by using the plurality of kinds of new softwares 202 transmitted from the first gateway ECU 110.

For performing function of updating the plurality of kinds of vehicle control softwares 92, the wireless-update control device 120 includes a software update means in the form of a software update portion 122 and a second storage device 124 such as a rewritable ROM.

The software update portion 122 is configured to determine whether at least one of the new softwares 202, which is not stored in the second storage device 124 and which is to be transmitted to the vehicle 8, is present in the server 200, or not. When determining that at least one of the new softwares 202 that is to be supplied to the vehicle 8 is present in the server 200, the software update portion 122 supplies, to the first gateway ECU 110, a command requesting the first gateway ECU 110 to receive the at least one of the new softwares 202 from the server 200 through the wireless communication R, namely, to download the at least one of the new softwares 202. Then, the software update portion 122 causes the at least one of the new softwares 202 received by the first gateway ECU 110 from the server 200, to be stored as a received new software or softwares 126 in the second storage device 124. The received new software or softwares 126 are the at least one of the new softwares 202 stored in the second storage device 124. The received new softwares 126 include received new programs 126P that are the new programs 202P stored in the second storage device 124, and also received new data 126D that are the new data 202D stored in the second storage device 124.

The software update portion 122 is configured to determine whether at least one of the new softwares 202, i.e., received new software or softwares 126, into each of which a corresponding one of the vehicle control softwares 92 needs to be rewritten, are present in the second storage deice 124 of the wireless-update control device 120, or not. When determining that the received new software or softwares 126, into each of which the corresponding vehicle control software 92 needs to be rewritten, are present in the second storage device 124, the software update portion 122 executes rewriting of the vehicle control software or softwares 92 that are to subjected to the rewriting or updating, by using the received new software or softwares 126.

The electronic control device 90, first gateway ECU 110 and wireless-update control device 120 cooperate with one another to constitute a vehicle control apparatus 150 that is configured to control the vehicle 8. The vehicle control apparatus 150 is further configured to execute rewriting of the plurality of kinds of vehicle control softwares 92 by using the plurality of kinds of new softwares 202, i.e., received new softwares 126, that have been transmitted through the wireless communication R from the server 200 (as the external device that is present apart from the vehicle 8 and is provided outside the vehicle 8). It is noted that the vehicle control apparatus 150 corresponds to “control apparatus” recited in the appended claims.

The second gateway ECU 130 is connected to the connector 140, for rewriting the plurality of kinds of vehicle control softwares 92 by using the external rewriting device 210 that is connected to the second gateway ECU 130 through the connector 140. It is noted that, although the vehicle 8 and the external rewriting device 210 are wire-connected to each other through the connector 140 in the present embodiment, they may be connected to each other in a wireless manner.

For performing various control operations in the vehicle 8, the electronic control device 90 further includes an AT shift control means in the form of an AT shift control portion 94, a hybrid control means in the form of a hybrid control portion 95, and a driving control means in the form of a driving control portion 96.

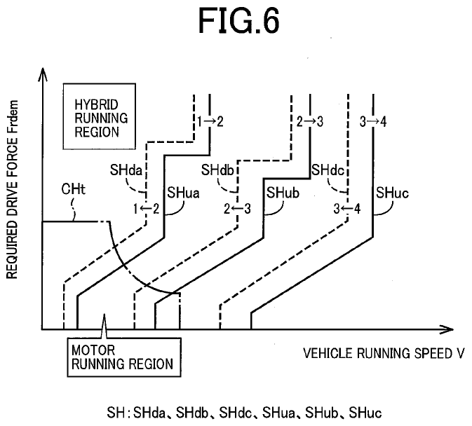

The AT shift control portion 94 is configured to determine a shifting action of the step-variable transmission portion 20, by using, for example, an AT-gear-position shifting map as shown in FIG. 6, which is a relationship obtained by experimentation or determined by an appropriate design theory, and to output the hydraulic control command signal Sat supplied to the hydraulic control unit 56, so as to execute a shift control operation in the step-variable transmission portion 20 as needed.

The AT-gear-position shifting map shown in FIG. 6 represents a predetermined relationship between two variables in the form of the vehicle running speed V and the required drive force Frdem, for example, wherein the relationship is used in the shift control operation executed in the step-variable transmission portion 20, and wherein the AT-gear-position shifting map contains a plurality of kinds of shifting lines SH in two-dimensional coordinates in which the vehicle running speed V and the required drive force Frdem are taken along respective two axes. The set of shifting lines SH are used to determine whether the shifting action is to be executed in the step-variable transmission portion 20, namely, whether a currently established one of the AT gear positions is to be switched to another one of the AT gear positions. It is noted that one of the two variables may be the output rotational speed No in place of the vehicle running speed V and that the other of the two variables may be the required drive torque Trdem, accelerator opening degree θacc or throttle valve opening degree 0th in place of the required drive force Frdem. The set of shifting lines SH in the AT gear position shifting map consist of shift-up lines SHua, SHub, SHuc (indicated by solid lines in FIG. 6) for determining a shift-up action of the step-variable transmission portion 20, and shift-down lines SHda, SHdb, SHdc (indicated by broken lines in FIG. 6) for determining a shift-down action of the step-variable transmission portion 20.

The hybrid control portion 95 has a function serving as an engine control means or portion for controlling the operation of the engine 14 and a function serving as a rotating machine control means or portion for controlling the operations of the first rotating machine MG1 and the second rotating machine MG2 via the inverter 52, and executes a hybrid drive control, for example, using the engine 14, the first rotating machine MG1 and the second rotating machine MG2 through these control functions.

The hybrid control portion 95 calculates a drive request amount in the form of the required drive force Frdem that is to be applied to the drive wheels 28, by applying the accelerator opening degree θacc and the vehicle running speed V to, for example, a drive request amount map that is a predetermined relationship. The required drive torque Trdem [Nm] applied to the drive wheels 28, a required drive power Prdem [W] applied to the drive wheels 28 or a required AT output torque applied to the output shaft 22, for example, can be used as the drive request amount, in addition to or in place of the required drive force Frdem [N].

The hybrid control portion 95 outputs the engine control command signal Se for controlling the engine 14 and the rotating-machine control command signals Smg for controlling the first and second rotating machines MG1, MG2, by taking account of a maximum chargeable amount Win of electric power that can be charged to the high-voltage battery 54, and a maximum dischargeable amount Wout of electric power that can be discharged from the high-voltage battery 54, such that the required drive power Prdem based on the required drive torque Trdem and the vehicle running speed V is obtained. The engine control command signal Se is, for example, a command value of an engine power Pe that is the power of the engine 14 outputting the engine torque Te at the current engine rotational speed Ne. The rotating-machine control command signal Smg is, for example, a command value of the generated electric power Wg of the first rotating machine MG1 outputting the MG1 torque Tg as the reaction torque of the engine torque Te at the MG1 rotational speed Ng which is the MG1 rotational speed Ng at the time of command signal Smg output, and is a command value of a consumed electric power Wm of the second rotating machine MG2 outputting the MG2 torque Tm at the MG2 rotational speed Nm which is the MG2 rotational speed Nm at the time of command signal Smg output.

The maximum chargeable amount Win of the high-voltage battery 54 is a maximum amount of the electric power that can be charged to the high-voltage battery 54, and indicates an input limit of the high-voltage battery 54. The maximum dischargeable amount Wout of the high-voltage battery 54 is a maximum amount of the electric power that can be discharged from the high-voltage battery 54, and indicates an output limit of the high-voltage battery 54. The maximum chargeable and dischargeable amounts Win, Wout are calculated by the electronic control device 90, for example, based on a battery temperature THbat and a charged state value SOC [%] of the high-voltage battery 54 that corresponds to a stored electric energy amount (charged electric energy amount) of the high-voltage battery 54. The charged state value SOC of the high-voltage battery 54 is a value indicative of a charged state of the high-voltage battery 54, and is calculated by the electronic control device 90, for example, based on the charging/discharging electric current that and the voltage Vbat of the high-voltage battery 54.

For example, when the transmission device 40 is operated as a continuously variable transmission as a whole by operating the continuously variable transmission portion 18 as a continuously variable transmission, the hybrid control portion 95 controls the engine 14 and controls the generated electric power Wg of the first rotating machine MG1 so as to attain the engine rotational speed Ne and the engine torque Te at which the engine power Pe achieving the required drive power Prdem is acquired in consideration of an optimum engine operation point, for example, and thereby provides the continuously variable shift control of the continuously variable transmission portion 18 to change the gear ratio γ0 of the continuously variable transmission portion 18. As a result of this control, the gear ratio γt (=γ0×γat=Ne/No) of the transmission device 40 is controlled in the case of operating the transmission device 40 as a continuously variable transmission. The optimum engine operation point is an engine operation point that maximizes a total fuel efficiency in the vehicle 8 including not only a fuel efficiency of the engine 14 but also a charge/discharge efficiency of the high-voltage battery 54, for example, when a required engine power Pedem is to be acquired. The engine operation point is an operation point of the engine 14 which is defined by a combination of the engine rotational speed Ne and the engine torque Te.

For example, when the transmission device 40 is operated as a step-variable transmission as a whole by operating the continuously variable transmission portion 18 as in a step-variable transmission, the hybrid control portion 95 uses a predetermined relationship, for example, a step-variable gear position shift map, to determine need of a shifting action of the transmission device 40 and provides the shift control of the continuously variable transmission portion 18 so as to selectively establish the plurality of overall gear positions in coordination with the shift control of the AT gear position of the step-variable transmission portion 20 by the AT shift control portion 94. The plurality of overall gear positions can be established by controlling the engine rotational speed Ne by the first rotating machine MG1 depending on the output rotational speed No so as to maintain the respective gear ratios γt.

The hybrid control portion 95 selectively establishes the EV running mode or the HV running mode as the running mode depending on a driving state, so as to cause the vehicle 8 to run in a selected one of the running modes which is selected by using, for example, a predetermined relationship in the form of a running-mode switching map as shown in FIG. 6. For example, the hybrid control portion 95 selects and establishes the EV running mode when the required drive power Prdem is relatively small so as to be in an EV running region, and selects and establishes the HV running mode when the required drive power Prdem is relatively large so as to be in an HV running region.

The running-mode switching map shown in FIG. 6 represents a predetermined relationship between two variables in the form of the vehicle running speed V and the required drive force Frdem, for example, and contains a boundary line between the HV running region and the EV running region in two-dimensional coordinates in which the vehicle running speed V and the required drive force Frdem are taken along respective two axes, wherein the boundary line is a predetermined running-mode switching line CHt (as indicated by one-dot chain line) that is used for determining whether the running mode is to be switched from one of the EV running mode and the HV running mode to another. It is noted that, in FIG. 6, the running-mode switching map is shown together with the AT-gear-position shifting map, for convenience of the description. Since the drive power source used to drive the vehicle 8 is switched upon switching of the running mode, the running-mode switching map serves also as a drive-power-source switching map.

Even when the required drive power Prdem is in the EV running region, the hybrid control portion 95 establishes the HV running mode, for example, in a case in which the charged state value SOC of the high-voltage battery 54 becomes less than a predetermined engine-start threshold value or in a case in which the engine 14 needs to be warmed up. The engine-start threshold value is a predetermined threshold value for determining that the charged state value SOC reaches a level at which the engine 14 must forcibly be started for charging the high-voltage battery 54.

When establishing the HV running mode during stop of operation of the engine 14, the hybrid control portion 95 executes a control for staring the engine 14. For staring the engine 14, the hybrid control portion 95 increases the engine rotational speed Ne by the first rotating machine MG1, and starts the engine 14, by igniting when the engine rotational speed Ne becomes at least a certain speed value that is an ignitable speed value. That is, the hybrid control portion 95 starts the engine 14 by cranking the engine 14 by the first rotating machine MG1.

The driving control portion 96 is capable of executing, as a drive control for driving the vehicle 8, a selected one of a manual drive control for driving the vehicle 8 in accordance with driving operations made by the vehicle driver and a drive assist control for driving the vehicle 8 without depending on the driving operations made by the vehicle driver. The manual drive control is for causing the vehicle 8 to run by manual operations, i.e., the driving operation manually made by the vehicle driver. The drive assist control is for causing the vehicle 8 to run, for example, with a drive assist by which the driving operations are automatically assisted. The drive assist control is, for example, the automatic drive control in which the vehicle 8 is accelerated, decelerated, braked and steered, depending on a target driving state that is automatically determined based on, for example, the map information and the destination point inputted by the vehicle driver. It is noted that the drive assist control may be broadly interpreted to encompass the cruise control in which some of the driving operations such as the steering operation are executed by the vehicle driver while the other driving operations such as the accelerating, decelerating and braking operations are automatically executed. When a drive-assist mode is not selected with the automatic-drive selecting switch and the cruise switch of the drive-assist setting switches 84 being placed in OFF, the driving control portion 96 establishes a manual drive mode so as to execute the manual drive control. When an automatic drive mode is selected with the automatic-drive selecting switch of the drive-assist setting switches 84 being placed in ON by the vehicle driver, the driving control portion 96 establishes the automatic drive mode so as to execute the automatic drive control.

The vehicle control programs 92P include, for example, an engine program 92Peg that is an engine control program to be used for controlling the engine 14 by the hybrid control portion 95, an MG1 program 92Pm1 that is a first-rotating-machine control program to be used for controlling the first rotating machine MG1 by the hybrid control portion 95, an MG2 program 92Pm2 that is a second-rotating-machine control program to be used for controlling the second rotating machine MG2 by the hybrid control portion 95, and an AT program 92Pat that is an automatic-transmission control program to be used for controlling the step-variable transmission portion 20 by the AT shift control portion 94. The MG2 program 92Pm2 is a rotating-machine control program to be used for controlling the rotating machine serving as the drive power source.

The control data 92D includes the plurality kinds of shifting lines SH, the running-mode switching line CHt, and limit values GD for limiting correction values or amounts which are obtained through learning control and by which respective control values Sct (used for controlling the vehicle 8) are to be corrected. The control values Sct are various command signals such as the above-described engine control command signal Se, rotating-machine control command signals Smg, hydraulic control command signal Sat, brake-control command signal Sbra and steering-control command signal Sste. The hydraulic control command signal Sat included in the control values Sct is, for example, an engaging-pressure command value in accordance with which the engaging pressure of the engagement device CB, whose operation state is switched in process of a shifting action executed in the step-variable transmission portion 20 by the AT shift control portion 94, is controlled to be changed. The AT shift control portion 94 corrects the engaging-pressure command value through the learning control, for example, such that the shifting action can be completed in the step-variable transmission portion 20 within an appropriate length of time, with a shitting shock being suppressed. The limit values GD are guard values provided for the respective various control values Sct, for example, such that each of the control values Sct is not changed excessively by the learning control.

By the way, the rewriting of the vehicle control software or softwares 92 is executable not only during running of the vehicle 8 but also during stop of the vehicle 8. It is preferable that the rewriting is executed, particularly, during the stop of the vehicle 8, i.e., in the OFF state of the electric power switch 87 of the vehicle 8, because it is possible to easily secure a time required for the rewriting of the vehicle control software or softwares 92 during the stop of the vehicle 8. However, when the vehicle control software or softwares 92 of the electronic control device 90 are to be rewritten in the OFF state of the electric power switch 87 of the vehicle 8, if the electric power stored in the auxiliary-device battery 57 is used for the rewriting of the vehicle control software or softwares 92, a stored electric energy amount (that may be referred also to as remaining capacity or charged electric energy amount) of the auxiliary-device battery 57 is reduced. As a result of the reduction, there is a risk that operations of the devices 59, to which the electric power is to be supplied from the auxiliary-device battery 57, would be negatively affected.

On the other hand, the in-vehicle system 10 includes the sub-battery 142 which is provided apart from the auxiliary-device battery 57, and which is configured, when the electric power switch 87 of the vehicle 8 is in the OFF state, to supply the electric power that is required for the rewriting of the vehicle control software or softwares 92 of the electronic control device 90. That is, the in-vehicle system 10 is constructed such that the rewriting of the vehicle control software or softwares 92 of the electronic control device 90 is executed with supply of the electric power to the vehicle control apparatus 150 from the sub-battery 142 when the electric power switch 87 of the vehicle 8 is in the OFF state. Thus, owing to this arrangement in which the rewriting of the vehicle control software or softwares 92 is executed with the supply of the electric power to the vehicle control apparatus 150 from the sub-battery 142 when the electric power switch 87 is in the OFF state, it is possible to suppress reduction of the stored electric energy amount of the auxiliary-device battery 57 and accordingly to secure the stored electric energy amount of the auxiliary-device battery 57. Consequently, it is possible to suppress negative influence on the operations of the devices 59 to which the electric power is to be supplied from the auxiliary-device battery 57. The sub-battery 142 has a battery voltage that is set to substantially the same value as that of the auxiliary-device battery 57, and is to be charged with the electric power generated by a generator (not shown) that is driven by the engine 14, for example. It is note that the sub-battery 142 corresponds to “second battery” recited in the appended claims.

The sub-battery 142 serves also as an electric power source for supplying the electric power to the compressor 48a and the electrically-operated oil pump 48b (that will be referred to as auxiliary devices 48 unless they are to be distinguished from each other). Therefore, since the electric power is supplied to the auxiliary devices 48 from the sub-battery 142 when the electric power switch 87 of the vehicle 8 is in the ON state, it is possible to suppress reduction of the stored electric energy amount of the auxiliary-device battery 57 even when the electric power switch 87 is in the ON state. That is, the sub-battery 142 as the second battery is configured to perform a first function during stop of the vehicle 8, and to perform a second function during running of the vehicle 8 (during which the auxiliary-device battery 57 as the first battery 57 is operated), wherein the sub-battery 142 is configured to perform, as the first function, the supply of the electric power to the vehicle control apparatus 150 for execution of the rewriting of the vehicle control software or softwares 92, and to perform, as the second function, the supply of the electric power to the auxiliary devices 48. Consequently, as a compared with an arrangement in which the electric power of the sub-battery 142 is used for only the rewriting of the vehicle control softwares 92, an amount of consumption of the electric power of the auxiliary-device battery 57 can be made smaller whereby a capacity of the auxiliary-device battery 57 can be reduced and a cost for the auxiliary-device battery 57 can be reduced by the reduction of the capacity. It is noted that each of the compressor 48a and the electrically-operated oil pump 48b, which are included in the auxiliary devices 48, corresponds to “auxiliary device” recited in the appended claims.

In a state in which the stored electric energy amount Qchg of the sub-battery 142 is small, it is difficult to execute the rewriting of the vehicle control software or softwares 92 with supply of the electric power from the sub-battery 142 even in the OFF state of the electric power switch 87. In the present embodiment, the wireless-update control device 120 functionally includes a stored-electric-energy-amount securing portion 128 as a stored-electric-energy-amount securing means for securing an appropriate value of the stored electric energy amount Qchg of the sub-battery 142.

The stored-electric-energy-amount securing portion 128 is configured, when the engine 14 is driven, to charge the sub-battery 142 by using the generator (not shown) that is driven by the engine 14.

Further, the stored-electric-energy-amount securing portion 128 is configured to determine whether the electric power switch 87 of the vehicle 8 is in the ON state or OFF state. When the electric power switch 87 is in the ON state, the stored-electric-energy-amount securing portion 128 calculates the stored electric energy amount Qchg of the sub-battery 142, and determines whether the stored electric energy amount Qchg is a predetermined target value Qchg* or more. The stored electric energy amount Qchg of the sub-battery 142 is calculated based on, for example, a battery temperature THsub, a charging/discharging electric current Isub and a voltage Vsub of the sub-battery 142 that are to be detected by a second battery sensor 144 provided in the sub-battery 142.

When the stored electric energy amount Qchg is not smaller than the target value Qchg*, the stored-electric-energy-amount securing portion 128 allows the sub-battery 142 to supply the electric power to the compressor 48a and the electrically-operated oil pump 48b in a normal manner. The supply of the electric power in the normal manner means no limitation on supply of the electric power from the sub-battery 142 to the compressor 48a and the electrically-operated oil pump 48b

On the other hand, when the stored electric energy amount Qchg is smaller than the target value Qchg*, the stored-electric-energy-amount securing portion 128 outputs a command for limiting the supply of the electric power from the sub-battery 142 to one or both of the compressor 48a and the electrically-operated oil pump 48b. With supply of the electric power from the sub-battery 142 to the compressor 48a and/or the electrically-operated oil pump 48b being limited, an amount of the electric power discharged from the sub-battery 142 is reduced. An amount of limitation of the electric power supplied from the sub-battery 142 is obtained by experimentation or determined by an appropriate design theory, specifically, such that the obtained or determined amount of limitation of the electric power supplied from the sub-battery 142 makes an amount of the electric power generated by the generator (that supplies the electric power to the sub-battery 142) larger than the amount of the electric power discharged from the sub-battery 142, whereby the stored electric energy amount Qchg of the sub-battery 142 is increased toward the target value Qchg*. The amount of limitation of the electric power supplied from the sub-battery 142 may be either a constant value or a variable value that is variable, as needed, depending on the amount of the electric power generated by the generator.

Each of the plurality of kinds of vehicle control softwares 92 corresponds to “software (rewriting of which is executable when an electric power switch of the vehicle is in an OFF state)” which is recited in the appended claims. The plurality of kinds of vehicle control softwares 92 include at least one software (hereinafter referred to as at least one first software) that is to be rewritten exclusively when the electric power switch 87 of the vehicle 8 is in the OFF state, and also at least one software (hereinafter referred to as at least one second software) that is rewritable irrespective of whether the electric power switch 87 is in the ON state or OFF state. Even when at least one received new software 126 is stored in the second storage device 124 in the ON state of the electric power switch 87, the at least one first software is not rewritten into the at least one received new software 126 until the electric power switch 87 is placed into the OFF state, if the at least one received new software 126 stored in the second storage device 124 corresponds to the at least one first software that is to be rewritten exclusively when the electric power switch 87 of the vehicle 8 is in the OFF state. The least one first software is to be involved directly in running of the vehicle 8, and includes, for example, the above-described AT program 92Pat that is to be rewritten exclusively when the electric power switch 87 is in the OFF state. If the AT program 92Pat is rewritten during running of the vehicle 8, the shift control operation cannot be performed in the step-variable transmission portion 20 during the rewriting of the AT program 92Pat whereby problem would be caused in running of the vehicle 8.

The above-described target value Qchg* of the stored electric energy amount Qchg is to be changed as needed during the ON state of the electric power switch 87. To this end, the stored-electric-energy-amount securing portion 128 is configured, when the electric power switch 87 is in the ON state, to change the target value Qchg* as needed. Specifically described, when detecting that the at least one received new software 126 is stored in the second storage device 124 during the ON state of the electric power switch 87, the stored-electric-energy-amount securing portion 128 detects a data volume Mdat of the at least one received new software 126. Then, the stored-electric-energy-amount securing portion 128 determines the target value Qchg*, depending on the detected data volume Mdat of the at least one received new software 126.

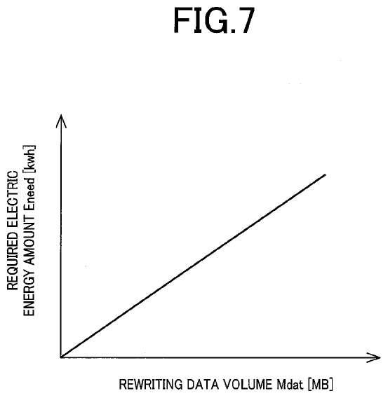

FIG. 7 is a view showing a relationship between the data volume (rewriting data volume) Mdat of the at least one received new software 126 and a required electric energy amount Eneed required for the rewriting that is to be made by the at least one received new software 126. In FIG. 7, the abscissa represents the data volume Mdat of the at least one received new software 126 while the ordinate represents the required electric energy amount Eneed required for the rewriting made by the at least one received new software 126. As shown in FIG. 7, the required electric energy amount Eneed is increased in proportion with the data volume Mdat of the at least one received new software 126. In view of this, the target value Qchg* of the stored electric energy amount Qchg of the sub-battery 142 is changed to a value that is increased in proportion with the data volume Mdat of the at least one received new software 126 by which the rewriting is to be made when the electric power switch 87 is in the OFF state. With the target value Qchg* being set to a value increased with increase of the data volume Mdat of the at least one received new software 126, it is possible to prevent shortage of the electric power of the sub-battery 142 during the rewriting of the vehicle control software or softwares 92 in the OFF state of the electric power switch 87 and accordingly to avoid suspension of the rewriting of the vehicle control software or softwares 92.

Where the at least one received new software 126 consists of a plurality of received new softwares 126 into which the plurality of kinds of vehicle control softwares 92 are to be rewritten in the OFF state of the electric power switch 87, the target value Qchg* of the stored electric energy amount Qcthg is set to a value dependent on one of the vehicle control softwares 92 that has a priority α higher than those of the others of the vehicle control softwares 92 in terms of the rewriting. The plurality of kinds of vehicle control softwares 92 are provided with respective priorities α (α1, α2, . . . ), and the target value Qchg* is set to a value dependent on the data volume Mdat of one of the received new softwares 126 corresponding to one of the vehicle control softwares 92 that has the highest priority α, namely, a value dependent on the data volume Mdat of one of the received new softwares 126 into which one of the vehicle control softwares 92 having the highest priority α is to be rewritten.

As ones of the vehicle control softwares 92 each having the high priority a, there are the AT program 92Pat as one of the vehicle control programs 92P and the set of shifting lines SH as one of the control data 92D, for example. These ones of the vehicle control softwares 92 are softwares that are to be involved directly in running of the vehicle 8, and it is preferable that these softwares are rewritten in an early stage, from a view point of, for example, running performance and fuel economy of the vehicle 8. Therefore, the softwares, which are to be involved directly in running of the vehicle 8, are given the high priorities α. Thus, since the target value Qchg* of the stored electric energy amount Qchg of the sub-battery 142 is determined based on the data volume Mdat of the one of the received new softwares 126 that corresponds to the one of the vehicle control softwares 92 having the highest priority α, the electric power required for the rewriting of the one of the vehicle control softwares 92 having the highest priority α, is secured when the electric power switch 87 is placed in the OFF state, so that the rewriting can be reliably executed.

The software update portion 122 is configured to determine whether the electric power switch 87 of the vehicle 8 is in the ON state or OFF state. When determining that the electric power switch 87 in the OFF state, the software update portion 122 determines whether the sub-battery 142 functions normally or not, based on the battery temperature THsub, charging/discharging electric current Isub and voltage Vsub of the sub-battery 142, and determines also whether the stored electric energy amount Qchg is at least the target value Qchg*. When an anomaly of the sub-battery 142 is detected or when the stored electric energy amount Qchg is smaller than the target value Qchg*, the software update portion 122 inhibits the rewriting of vehicle control software or softwares 92. When the stored electric energy amount Qchg is not smaller than the target value Qchg* without the anomaly of the sub-battery 142 being detected, the software update portion 122 executes the rewriting by starting from one of the vehicle control softwares 92 that has the highest priority α.

When the rewriting of the one of the vehicle control softwares 92 having the highest priority α has been completed, the software update portion 122 determines whether the rewriting of one of the vehicle control softwares 92 having the second highest priority α is to be executed or not. To this end, the software update portion 122 obtains the required electric energy amount Eneed, based on the relationship shown in FIG. 7, depending on the data volume Mdat of one of the received new softwares 126 corresponding to the one of the vehicle control softwares 92 having the second highest priority α. Then, the software update portion 122 determines, based on the obtained required electric energy amount Eneed, a lower threshold value Qlow (that practically corresponds to the target value Qchg*) of the stored electric energy amount Qchg of the sub-battery 142, which enables the rewriting of the one of the vehicle control softwares 92 having the second highest priority α. Then, the software update portion 122 determines whether the stored electric energy amount Qchg is at least the lower threshold value Qlow or not.

When the stored electric energy amount Qchg of the sub-battery 142 is smaller than the lower threshold value Qlow, the software update portion 122 inhibits the rewriting of the vehicle control software or softwares 92. When the stored electric energy amount Qchg of the sub-battery 142 is not smaller than the lower threshold value Qlow, the software update portion 122 executes the rewriting of the vehicle control software or softwares 92. Thus, the rewriting is executed with a higher priority being given to the vehicle control software 92 having the higher priority. Namely, the rewriting is executed such that the vehicle control software 92 having the higher priority a is rewritten earlier than the other vehicle control softwares 92. When it is determined that the rewriting would be suspended, the rewriting is inhibited.

Further, in the present embodiment, the in-vehicle system 10 is constructed such that the rewriting of the above-described at least one second software of the electronic control device 90 is executable when the electric power switch 87 of the vehicle 8 is in the ON state as well as in the OFF state, and such that the rewriting of the at least one second software is executed with the supply of the electric power from the sub-battery 142 to the electronic control device 90 when the electric power switch 87 is in the ON state as well as in the OFF state. That is, regarding the at least one of the vehicle control softwares 92 which is rewritable even when the electric power switch 87 is in the ON state, the rewriting is executed in the ON state of the electric power switch 87 with use of the electric power supplied from the sub-battery 142, whereby an amount of consumption of the electric power of the auxiliary-device battery 57 is reduced. Therefore, it is possible to reduce a capacity of the auxiliary-device battery 57 and to reduce a cost for the auxiliary-device battery 57 by the reduction of the capacity.

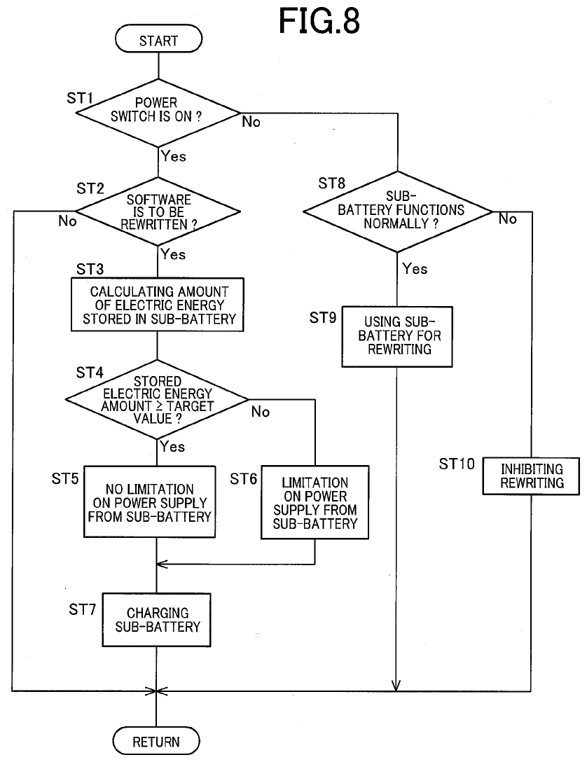

FIG. 8 is a flow chart showing a main part of a control routine executed by the vehicle control apparatus 150 that constitutes the in-vehicle system 10, namely, a control routine that is executed for rewriting the vehicle control software or softwares 92 in the OFF state of the electric power switch 87 and securing the required electric energy amount required for rewriting the vehicle control software or softwares 92. This control routine is constantly executed irrespective of whether the electric power switch 87 is in the ON state or OFF state.

This control routine is initiated with step ST1 corresponding to control function of the software update portion 122, which is implemented to determine whether the electric power switch 87 is in the ON state (IG switch ON) or not. When the electric power switch 87 is in the ON state, an affirmative determination is made at step ST1 and the control flow goes to step ST2. When the electric power switch 87 is in the OFF state, a negative determination is made at step ST1 and the control flow goes to step ST8.

At step ST2 corresponding to control function of the software update portion 122, it is determined whether at least one of the vehicle control softwares 92 is to be rewritten or not, depending on whether at least one of the received new softwares 126 is stored in the second storage device 124 or not. When a negative determination is made at step ST2, one cycle of execution of the control routine is terminated. When an affirmative determination is made at step ST2, the control flow goes to step ST3 corresponding to control function of the stored-electric-energy-amount securing portion 128, which is implemented to calculate the stored electric energy amount Qchg of the sub-battery 142 and also the target value Qchg* of the stored electric energy amount Qchg. In this instance, the target value Qchg* is calculated based on the data volume Mdat of the at least one of the received new softwares 126 into which the at least one of the vehicle control softwares 92 is to be rewritten. Step ST3 is followed by step ST4 corresponding to control function of the stored-electric-energy-amount securing portion 128, which is implemented to determine whether the stored electric energy amount Qchg of the sub-battery 142 is at least target value Qchg* (Qchg≥Qchg*) or not.

When an affirmative determination is made at step ST4, the control flow goes to step ST5. When a negative determination is made at step ST4, the control flow goes to step ST6. At step ST5 corresponding to control function of the stored-electric-energy-amount securing portion 128, the sub-battery 142 is allowed to supply the electric power to the compressor 48a and the electrically-operated oil pump 48b as normally. That is, at step ST5, no limitation is imposed on supply of the electric power from the sub-battery 142 to the compressor 48a and the electrically-operated oil pump 48b.

On the other hand, at step ST6 corresponding to control function of the stored-electric-energy-amount securing portion 128, a limitation is imposed on the supply of the electric power from the sub-battery 142 to the compressor 48a and the electrically-operated oil pump 48b. With the limitation being imposed on the supply of the electric power to the compressor 48a and the electrically-operated oil pump 48b, an amount of the electric power discharged from the sub-battery 142 is made smaller than in a normal state. Step ST5 or step ST6 is followed by step ST7 corresponding to control function of the stored-electric-energy-amount securing portion 128, which is implemented to execute a control for charging the sub-battery 142 with the electric power generated by the driven engine 14.

When a negative determination is made at step ST1, namely, when the electric power switch 87 is in the OFF state, the control flow goes to step ST8 corresponding to control function of the software update portion 122, which is implemented to determine whether the sub-battery 142 functions normally or not. Specifically, at step ST8, it is determined whether an anomaly is absent in the sub-battery 142 or not, and whether the stored electric energy amount Qchg of the sub-battery 142 is at least the target value Qchg* or not. When the stored electric energy amount Qchg is not smaller than the target value Qchg* without the anomaly being detected in the sub-battery 142, an affirmative determination is made at step ST8 and the control flow goes to step ST9. When the stored electric energy amount Qchg is smaller than the target value Qchg* and/or when the anomaly is detected in the sub-battery 142, a negative determination is made at step ST8, the control flow goes to step ST10.

At step ST9 corresponding to control function of the software update portion 122, the sub-battery 142 is used as an electric power source for the rewriting, so that, when at least one of the received new softwares 126 is stored in the second storage device 124 of the wireless-update control device 120, the rewriting of a corresponding one or ones of the vehicle control softwares 92 is executed. On the other hand, at step ST10 corresponding to control function of the software update portion 122, even when at least one of the received new softwares 126 is stored in the second storage device 124, the rewriting of a corresponding one or ones of the vehicle control softwares 92 is inhibited so as to be not executed.

As described above, in the present embodiment, the in-vehicle system 10 is constructed such that the rewriting of the vehicle control softwares 92 is executed with supply of the electric power from the sub-battery 142 to the vehicle control apparatus 150 when the electric power switch 87 of the vehicle 8 is in the OFF state, whereby reduction of the stored electric energy amount of the auxiliary-device battery 57 is suppressed in the OFF state of the electric power switch 87. Consequently, it is possible to prevent negative influence on the operations of the devices 59 to which the electric power is to be supplied from the auxiliary-device battery 57, while rewriting the vehicle control softwares 92 of the electronic control device 90 in the OFF state of the electric power switch 87.

In the present embodiment, the in-vehicle system 10 is constructed such that the rewriting of the vehicle control softwares 92 is executable when the electric power switch 87 of the vehicle 8 is in the ON state as well as when the electric power switch 87 is in the OFF state, and such that the rewriting of the vehicle control softwares 92 is executed with the supply of the electric power from the sub-battery 142 to the vehicle control apparatus 150 when the electric power switch 87 of the vehicle 8 is in the ON state as well as when the electric power switch 87 is in the OFF state. Thus, the vehicle control softwares 92 of the electronic control device 90 can be rewritten in the ON state of the electric power switch 87, and the electric power supplied from the sub-battery 142 can be used even in the ON state of the electric power switch 87. Further, in the present embodiment, the sub-battery 142 can be used as the electric power source of the compressor 48a and the electrically-operated oil pump 48b included in the auxiliary devices 48 that are to be provided in the vehicle.

While the preferred embodiment of this invention has been described in detail by reference to the drawings, it is to be understood that the invention may be otherwise embodied.

For example, in the above-described embodiment, when the electric power switch 87 is in the ON state, the rewriting of the vehicle control software or softwares 92 (i.e., second software or softwares) is executed by the electric power supplied from the sub-battery 142. However, this arrangement may be modified such that, when the electric power switch 87 is in the ON state, the rewriting is executed by the electric power supplied from the auxiliary-device battery 57.

In the above-described embodiment, when the plurality of vehicle control softwares 92 are to be rewritten in the OFF state of the electric power switch 87, the target value Qchg* of the stored electric energy amount Qchg of the sub-battery 142 is set to the value dependent on the data volume Mdat of one of the received new softwares 126 corresponding to one of the vehicle control softwares 92 that has the highest priority a. However, this arrangement is not essential, and may be modified such that the required electric energy amount Eneed is calculated based on the relationship shown in FIG. 7, depending on a total of the data volumes Mdat of the received new softwares 126 corresponding to the vehicle control softwares 92, and the target value Qchg* of the stored electric energy amount Qchg is set to a value dependent on the required electric energy amount Eneed dependent on the total of the data volumes Mdat.

In the above-described embodiment, the functions of the software update portion 122 and the second storage device 124 are provided in the wireless-update control device 120. However, this arrangement is not essential. For example, an entirety or a part of the function of the software update portion 122 may be provided in the electronic control device 90 or the first gateway ECU 110. Further, an entirety or a part of the function of the second storage device 124 may be provided in the electronic control device 90. That is, the arrangement may be modified as long as the functions of the software update portion 122 and the second storage device 124 are provided in the vehicle control apparatus 150, within a range where there is no inconvenience.

In the above-described embodiment, the in-vehicle system 10 is provided in the hybrid vehicle including the electrically-operated continuously-variable transmission portion 18. However, the present invention is applicable also to a vehicle other than the hybrid vehicle. For example, the present invention is applicable also to a vehicle including a single drive power source in the form of the engine 14 and not including the electrically-operated continuously-variable transmission portion 18. In this case, an alternator provided in the engine 14 advantageously serves as the generator for the sub-battery 142. Further, the mechanically-operated step-variable transmission portion 20 does not necessarily have to be provided, but may be replaced with a belt-type or other type continuously-variable transmission portion.

In the above-described embodiment, the compressor 48a and the electrically-operated oil pump 48b are to be driven by the electric power supplied from the sub-battery 142. However, this arrangement is not essential. For example, the lamps and/or the audio device of the vehicle 8 may constitute the auxiliary device provided in the vehicle 8, so as to be operated by the electric power supplied from the sub-battery 142. That is, any device, which can be driven or operated by the electric power supplied from the sub-battery 142, may constitute the auxiliary device.

It is to be understood that the embodiment described above is given for illustrative purpose only, and that the present invention may be embodied with various modifications and improvements which may occur to those skilled in the art.

### NOMENCLATURE OF ELEMENTS

8: vehicle
10: in-vehicle system
48a: compressor (auxiliary device that is to be provided in vehicle)
48b: electrically-operated oil pump (auxiliary device that is to be provided in vehicle)
57: auxiliary-device battery (first battery)
59: devices
87: electric power switch
90: electronic control device
92: vehicle control software (software)
142: sub-battery (second battery)
150: vehicle control apparatus (control apparatus)

What is claimed is:

1. An in-vehicle system that is to be provided in a vehicle,
the in-vehicle system comprising:
a control apparatus;
a first battery configured to supply an electric power to devices that are to be provided in the vehicle; and
a second battery provided apart from the first battery,
wherein the in-vehicle system is constructed such that rewriting of a software of the control apparatus is executable when an electric power switch of the vehicle is in an OFF state, and such that the rewriting of the software is executed with supply of the electric power from the second battery to the control apparatus when the electric power switch of the vehicle is in the OFF state.

2. The in-vehicle system according to claim 1,
wherein the in-vehicle system is constructed such that the rewriting of the software of the control apparatus is executable when the electric power switch of the vehicle is in an ON state as well as when the electric power switch of the vehicle is in the OFF state, and such that the rewriting of the software is executed with the supply of the electric power from the second battery to the control apparatus when the electric power switch of the vehicle is in the ON state as well as when the electric power switch of the vehicle is in the OFF state.

3. The in-vehicle system according to claim 1,
wherein the second battery serves as an electric power source of an auxiliary device that is to be provided in the vehicle.

4. The in-vehicle system according to claim 1,
wherein the control apparatus is configured to control the vehicle by using the software, and
wherein the control apparatus is included in the devices to which the electric power is to be supplied from the first battery.

5. The in-vehicle system according to claim 1, further comprising:
a rotating machine serving as a drive power source for driving the vehicle; and
a main battery which is provided apart from the first and second batteries, and which is configured to supply the electric power to the rotating machine.

6. The in-vehicle system according to claim 1,
wherein the second battery is configured to perform a first function during stop of the vehicle, and to perform a second function during running of the vehicle during which the first battery is operated, and
wherein the second battery is configured to perform, as the first function, the supply of the electric power to the control apparatus for execution of the rewriting of the software.

7. The in-vehicle system according to claim 6,
wherein the control apparatus is configured, when the second battery performs the second function, to determine whether the second battery functions normally or not, and to execute the rewriting of the software with the supply of the electric power from the second battery in case of determination that the second battery functions normally.

8. The in-vehicle system according to claim 6,
wherein the control apparatus is configured, when the second battery performs the second function, to determine a target value of a stored electric energy amount of the second battery.

9. The in-vehicle system according to claim 8,
wherein the target value is determined based on a data volume of a new software corresponding to the software that needs to be rewritten.

10. The in-vehicle system according to claim 8,
wherein the target value is determined based on a data volume of a new software corresponding to the software that has a high priority in terms of the rewriting.

11. The in-vehicle system according to claim 8,
wherein the control apparatus is configured to limit the second performance of the second battery when an actual value of the stored electric energy amount of the second battery is smaller than the target value.

12. The in-vehicle system according to claim 6,
wherein the second battery is configured to perform, as the second function, the supply of the electric power to a compressor of an air conditioner that is to be provided in the vehicle.

13. The in-vehicle system according to claim 6,
wherein the second battery is configured to perform, as the second function, the supply of the electric power to an electrically-operated oil pump that is to be provided in the vehicle.
